(19) United States
(12) Patent Application Publication
(10) Pub. No.: US 2025/0192465 A1
(43) Pub. Date: Jun. 12, 2025

(54) Optimized Spring Cage

(71) Applicant: HIRSCHMANN AUTOMOTIVE GMBH, Rankweil/Brederis (AT)

(72) Inventors: Andreas METZLER, Muntlix (Zwischenwasser) (AT); Simon DÜNSER, Bludenz (AT)

(21) Appl. No.: 18/844,172

(22) PCT Filed: Apr. 20, 2023
(86) PCT No.: PCT/EP2023/060285

§ 371 Date: Sep. 5, 2024

(30) Foreign Application Priority Data
Apr. 26, 2022 (DE) 10 2022 110 003.0

(51) Int. Cl. H01R 13/187

(52) U.S. Cl. CPC H01R 13/187

(57) ABSTRACT

The invention relates to a contact partner, in particular a socket contact, which can be plugged together with a pin contact to form a plug-in connection. The socket contact is in the form of a punched rolled part and has a contact region and a crimp region. The contact region is formed by a circumferential housing. Two mutually spaced rings are provided within the housing, which rings are connected to each other by at least one elongate contact spring. A single-side spring cutout of each contact spring is provided at the rear collar. Contacting takes place by means of the spring to the main body, whereby the contacting takes place radially by means of the rigidly embossed contact domes on the outer face of the collar of the spring, and also takes place directly by means of the radial inner surface of the main body.

The invention relates to a contact partner of a plug connector, in particular a socket contact, which can be plugged together with a pin contact to form a plug connection, wherein the socket contact is designed as a punched rolling part and has a contact area and a crimp area, wherein the contact area is formed by a circumferential housing and two mutually spaced rings are provided within the housing, which are connected to one another via at least one elongated contact spring, in accordance with the features of the generic term of claim 1.

Such a contact partner, designed as a socket contact, is known from DE 10 2015 213 674 A1.

The known socket contact can be plugged together with a pin contact to form a plug connection, wherein the socket contact is designed as a punched rolling part and has a contact area and a crimp area, wherein the contact area is formed by a circumferential housing and two rings are provided within the housing which are spaced apart from one another and are connected to one another via at least one elongated contact spring.

The invention is based on the object of improving this contact partner.

This object is achieved by the features of claim 1.

According to the invention, a single-side spring cutout of each, in particular second, contact spring is provided at the rear collar (also referred to as a ring), wherein contact is made (in particular via contact points) via the spring to the main body, whereby contact is made via the rigidly embossed contact domes on the outer side radially of the collar of the spring and also directly via the radial inner surface of the main body.

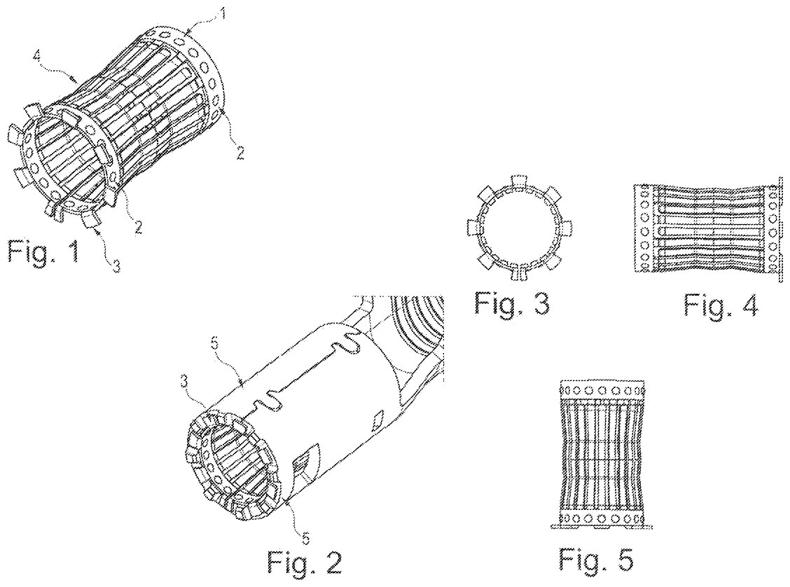

Further alternative or supplementary embodiments of the invention are shown in the drawings (FIGS. 1 to 5) and the associated description.

FIG. 1 shows a contact partner of a plug connector. The contact partner designed as a socket contact in this embodiment example is formed as a punched rolling part and has a contact area (the front area when looking at FIG. 1) and a crimp area (the rear, only partially shown area when looking at FIG. 1), wherein the contact area is formed by a circumferential housing and two mutually spaced rings are provided within the housing, which are fully connected to one another via at least one elongated contact spring 8 (only recognizable in FIG. 2).

FIG. 2 shows the socket contact according to FIG. 1, wherein the circumferential housing is omitted to make the elongated contact spring, or more precisely the contact cage, recognizable.

FIG. 3 shows a top view of the socket contact from the front and FIGS. 4 and 5 show top views of the socket contact from the outside.

FIG. 2 shows a single-side spring cutout according to the invention of each preferably 2nd contact spring at the rear collar (ring). The contact (contact points) via the spring to the main body is therefore not only made via the rigidly embossed contact domes 1 on the outer radial side of the collar 2 of the spring, but also directly via the radial inner surface of the main body and therefore adapts better to any possible out-of-roundness of the contact box. The contact box is, for example, the contact pin of the mating connector, which is inserted into the socket contact shown.

The front ring has one or preferably several welding lugs 3.

The front ring forms a contact cage 4 together with the rear ring and the springs arranged between them, for example in the form of narrow, elongated spring plates. This contact cage is manufactured as a separate component in relation to the main body 5 and is inserted into this main body 5 once it has been assembled.

A group of springs, in particular spring plates, is mounted on both the front and rear rings. This means that these springs are mounted to the two rings in a non-detachable manner, for example by welding, soldering or similar. Alternatively, these springs, in particular the several spring plates running parallel around the outer circumference of the contact cage 4, can form a one-piece component together with the two rings.

The other group of springs, in particular spring plates, is mounted only on the front ring (alternatively only on the rear ring). This means that these springs are mounted non-detachably on only one of the two rings, for example by welding, soldering or similar. Alternatively, the ends of these springs, in particular the multiple spring plates extending and arranged in parallel around the outer circumference of the contact cage 4, can form a single-piece component together with the ring from which they extend. The other end of each spring (spring plate) is free and ends at a distance from the other ring. This is known as a single-side spring cutout. The free end of these springs (spring plates) allows greater radial freedom of movement than the springs (spring plates) of the other group, which are connected to both rings.

As shown in FIG. 1, the two groups of spring plates mentioned above, which alternate in the circumferential direction, form a one-piece component together with the two rings. This component can initially be produced from a flat sheet using a punching method, wherein the punched flat part is rolled into the contact cage 4, i.e. brought into the cylindrical shape shown. Ideally, the joint edge does not form a gap, but if it does, only a small gap. The two adjoining sides can be permanently joined together, again for example by welding, soldering or similar. In addition or alternatively, the rolled shape of the contact cage 4 can also be held together by the main body 5 when the contact cage 4 has been inserted into the main body 5.

The preferably curved welding lugs 3 on the front of the contact cage 4, which initially protrude in the initial state, are welded to the main body 5 after assembly. The cutout on the end face of the main body 5 protects and stabilizes the welding point or the spring cage (contact cage 4).

### LIST OF REFERENCE SIGNS

1. contact dome
2. collar (also known as a ring)
3. welding lug
4. contact cage
5. Main body

1.-8. (canceled)

9. A contact partner configured as a socket contact that can be plugged together with a pin contact to form a plug-in connection, wherein the socket contact is configured as a punched rolling part and comprising a contact area and a crimp area, wherein the contact area is formed by a circumferential housing and two rings are provided within the circumferential housing, the two rings are spaced apart from one another and are connected to one another via at least one elongated contact spring, the at least one elongated contact spring including a rear collar and a one-side spring cutout at the rear collar, wherein the contact partner is configured such that contacting takes place via the at least one elongated contact spring to a main body, whereby contacting takes place via rigidly embossed contact domes on an outer side radially of the rear collar of the at least one elongated contact spring and also directly via a radial inner surface of the main body.

10. The contact partner according to claim 9, wherein a group of springs is non-detachably mounted on the two rings.

11. The contact partner according to claim 9, wherein a group of springs together with the two rings form a one-piece component.

12. The contact partner according to claim 9, wherein another group of springs is mounted only on one ring of the two rings.

13. The contact partner according to claim 12, wherein the ends of the another group of springs together with the one ring from which the another group of springs extends form a one-piece component, wherein the other end of each spring of the another group of springs is free and ends at a distance from the other one of the two rings.

14. The contact partner according to claim 9, wherein one of the two rings includes one or more welding lugs.

15. The contact partner according to claim 14, wherein the one or more welding lugs comprise one or more initially protruding and/or curved welding lugs on a front of a contact cage that are welded to the main body after being mounted in the contact cage.

16. The contact partner according to claim 9, wherein a front ring of the two rings includes one or more welding lugs.

17. The contact partner according to claim 16, wherein the one or more welding lugs comprise one or more initially protruding and/or curved welding lugs on a front of a contact cage that are welded to the main body after being mounted in the contact cage.

18. The contact partner according to claim 9, wherein at least one spring of the contact partner is configured as an elongated narrow spring plate.

19. The contact partner according to claim 9, wherein all springs of the contact partner are configured as elongated narrow spring plates.

20. The contact partner according to claim 9, wherein the at least one elongated contact spring comprises a second elongated contact spring that includes the one-side spring cutout at the rear collar.

21. The contact partner according to claim 9, wherein the contact partner is configured such that contact points takes place via the at least one elongated contact spring to the main body.

22. A socket contact pluggable together with a pin contact to form a plug-in connection, wherein the socket contact is configured as a punched rolling part, the socket contact comprising:
a crimp area; and
a contact area formed by a circumferential housing and two rings within the circumferential housing, the two rings are spaced apart from one another and are connected to one another via at least one elongated contact spring;
wherein the at least one elongated contact spring includes a rear collar and a one-side spring cutout at the rear collar;
wherein the socket contact is configured such that contacting takes place via the at least one elongated contact spring to a main body, whereby contacting takes place via rigidly embossed contact domes on an outer side radially of the rear collar of the at least one elongated contact spring and also directly via a radial inner surface of the main body.

23. The socket contact according to claim 22, wherein the socket contact includes a group of springs, and wherein:
the group of springs is non-detachably mounted on the two rings; and/or
the group of springs together with the two rings form a one-piece component.

24. The socket contact according to claim 22, wherein the socket contact includes another group of springs mounted only on the one ring.

25. The socket contact according to claim 24, wherein the ends of the another group of springs together with the one ring from which the another group of springs extends form a one-piece component, wherein the other end of each spring of the another group of springs is free and ends at a distance from the other one of the two rings.

26. The socket contact according to claim 22, wherein a front ring of the two rings includes one or more initially protruding and/or curved welding lugs on a front of a contact cage that are welded to the main body after being mounted in the contact cage.

27. The socket contact according to claim 22, wherein at least one or more springs of the socket contact are configured as an elongated narrow spring plate.

28. The socket contact according to claim 22, wherein:
the at least one elongated contact spring comprises a second elongated contact spring that includes the one-side spring cutout at the rear collar; and/or
the socket contact is configured such that contact points takes place via the at least one elongated contact spring to the main body.
